(19) United States
(12) Patent Application Publication
(10) Pub. No.: US 2026/0099556 A1
(43) Pub. Date: Apr. 9, 2026

(54) WEBPAGE INDEX INFORMATION ACQUISITION METHOD AND APPARATUS, COMPUTER DEVICE, AND STORAGE MEDIUM

(71) Applicant: SHENZHEN TCL NEW TECHNOLOGY CO., LTD., Shenzhen, Guangdong (CN)

(72) Inventor: Yang LUO, Shenzhen, Guangdong (CN)

(73) Assignee: SHENZHEN TCL NEW TECHNOLOGY CO., LTD., Shenzhen, Guangdong (CN)

(21) Appl. No.: 19/114,448

(22) PCT Filed: Aug. 10, 2023
(86) PCT No.: PCT/CN2023/112126

§ 371 Date: Mar. 23, 2025

(30) Foreign Application Priority Data
Sep. 22, 2022 (CN) 202211159748.7

(51) Int. Cl. G06F 16/951; G06F 9/48

(52) U.S. Cl. CPC G06F 16/951; G06F 9/4881

(57) ABSTRACT

A webpage index information acquisition method and apparatus, a computer device, and a storage medium are provided. In the method, a main thread corresponding to a target webpage is monitored, and if a first long task in the main thread ends, webpage index information is generated according to an end time point of the first long task and a thread task monitored in a preset time window. A start time point of the preset time window is the end time point of the first long task.

This application claims priority to Chinese Patent Applications No. 202211159748.7, filed on Sep. 22, 2022 and entitled “WEBPAGE INDEX INFORMATION ACQUISITION METHOD AND APPARATUS, COMPUTER DEVICE, AND STORAGE MEDIUM”. The entire disclosures of the above application are incorporated herein by reference.

### TECHNICAL FIELD

The present application relates to the field of data processing technology, and in particular to a webpage index information acquisition method and apparatus, a computer device, and a computer-readable storage medium (storage medium for short).

### BACKGROUND TECHNOLOGY

TTI (Time to Interactive) is configured to identify a time that users can operate a webpage interface, and is an important indicator for measuring a relevant performance of the webpage interface.

In an existing technology, a current measurement of the TTI is performed in an experimental environment, and the TTI is measured by loading the webpage interface on a fixed device in a certain network environment.

### Technical Problem

In an actual use of mobile devices, due to differences in mobile devices and network environments, there is a certain error between the TTI and the TTI measured in the experimental environment.

### SUMMARY OF INVENTION

Based on this, it is necessary to provide a webpage index information acquisition method and apparatus, a computer device, and a storage medium to improve an accuracy of webpage index information in response to the above technical problems.

In a first aspect, the present application provides a webpage index information acquisition method, and the method includes:

monitoring a main thread corresponding to a target webpage.

if a first long task in the main thread ends, generating webpage index information of the target webpage according to an end time point of the first long task and a thread task monitored in a preset time window, where a start time point of the preset time window is the end time point of the first long task.

In some embodiments of the present application, the thread task includes a long task.

the generating the webpage index information of the target webpage according to the end time point of the first long task and the thread task monitored in the preset time window includes:

if a second long task is monitored in the preset time window, updating the second long task to the first long task, and continuing to generate the webpage index information of the target webpage according to the end time point of the first long task and the thread task monitored in the preset time window.

In some embodiments of the present application, the thread task includes a webpage resource request.

the generating the webpage index information of the target webpage according to the end time point of the first long task and the thread task monitored in the preset time window includes:

acquiring a number of network resource requests monitored in the preset time window.

if the number of the network resource requests is less than a preset request threshold, generating the webpage index information of the target webpage based on the end time point of the first long task.

In some embodiments of the present application, the generating the webpage index information of the target webpage based on the end time point of the first long task includes:

determining the end time point of the first long task as a time to interactive of the target webpage.

In some embodiments of the present application, the monitoring the main thread corresponding to the target webpage includes:

detecting an opening operation for the target webpage.

when the opening operation for the target webpage is detected, acquiring a first meaningful paint of the target webpage.

starting to monitor the main thread corresponding to the target webpage after the first meaningful paint.

In some embodiments of the present application, the acquiring the first meaningful paint of the target webpage includes:

acquiring a site type of the target webpage.

determining a target page element from page elements of the target webpage based on the site type of the target webpage.

determining the first meaningful paint of the target webpage according to a loading time point of the target page element.

In some embodiments of the present application, before generating the webpage index information of the target webpage according to the end time point of the first long task and the thread task monitored in the preset time window, the method further includes:

acquiring a webpage loading time between the first meaningful paint and the end time point of the first long task.

determining a window length of the preset time window according to the webpage loading time.

In a second aspect, the present application provides a webpage index information acquisition apparatus, and the apparatus includes:

a thread monitoring module configured to monitor a main thread corresponding to a target webpage.

a webpage index acquisition module configured to generate webpage index information of the target webpage according to an end time point of a first long task and a thread task monitored in a preset time window when the first long task in the main thread ends, where a start time point of the preset time window is the end time point of the first long task.

In a third aspect, the present application also provides a computer device, and the computer device includes:

one or more processors.

a memory.

one or more applications, where the one or more applications are stored in the memory and configured to be executed by the processor to implement the webpage index information acquisition method.

In a fourth aspect, the present application also provides a computer-readable storage medium, on which a computer program is stored, and the computer program is loaded by a processor to execute steps of the webpage index information acquisition method.

### Beneficial Effects

In the webpage index information acquisition method and apparatus, the computer device, and the storage medium of the present application, the main thread corresponding to the target webpage is monitored, and if the first long task in the main thread ends, the webpage index information of the target webpage is generated according to the end time point of the first long task and the thread task monitored in the preset time window. The start time point of the preset time window is the end time point of the first long task. By monitoring the main thread loaded by an webpage interface, the end time point of the first long task is acquired in real time, and the webpage index information of the target webpage is generated based on the end time point of the first long task and a task status of the thread task in the preset time window with the end time point of the first long task as the start time point, so as to acquire the webpage index information of the target webpage in an actual use environment of different terminals. An accuracy of the webpage index information is improved, and accurate data is provided for an optimization of webpage codes and interactive operations of the target webpage.

### BRIEF DESCRIPTION OF THE DRAWINGS

In order to more clearly illustrate technical solutions in embodiments of the present application, accompanying drawings required for use in the description of the embodiments will be briefly introduced below. Apparently, the drawings described below are only some embodiments of the present application. For those skilled in the art, other drawings can be obtained based on these drawings without paying any creative efforts.

FIG. 1 is a schematic diagram of a scenario of a webpage index information acquisition method in an embodiment of the present application.

FIG. 2 is a flowchart of a webpage index information acquisition method in an embodiment of the present application.

FIG. 3 is a flowchart of steps of monitoring a main thread corresponding to a target webpage in an embodiment of the present application.

FIG. 4 is a flowchart of another webpage index information acquisition method in an embodiment of the present application.

FIG. 5 is a structural diagram of a webpage index information acquisition apparatus in an embodiment of the present application.

FIG. 6 is a structural diagram of a computer device in an embodiment of the present application.

### DETAILED DESCRIPTION OF THE EMBODIMENTS

The following will be combined with the accompanying drawings in the embodiments of the present application to clearly and completely describe the technical solutions in the embodiments of the present application. Apparently, the described embodiments are only part of the embodiments of the present application, not all of the embodiments. Based on the embodiments in the present application, all other embodiments obtained by those skilled in the art without creative efforts are within the scope of protection of the present application.

In the description of this application, terms “first” and “second” are used for descriptive purposes only and should not be understood as indicating or implying relative importance or implicitly indicating the number of technical features indicated. Thus, a feature defined as “first” or “second” may explicitly or implicitly include one or more of the features. In the description of this application, the meaning of “plurality” is two or more, unless otherwise clearly and specifically defined.

In the description of the present application, a word “for example” is used to mean “used as an example, illustration, or description”. Any embodiment described as “for example” in the present application is not necessarily to be construed as being more preferred or advantageous than other embodiments. In order to enable any technician in the field to implement and use the present application, the following description is given. In the following description, details are listed for the purpose of explanation. It should be understood that a person of ordinary skill in the art can recognize that the present application can be implemented without using these specific details. In other examples, well-known structures and processes will not be elaborated in detail to avoid obscuring the description of the present application with unnecessary details. Therefore, the present application is not intended to be limited to the embodiments shown, but is consistent with the widest scope consistent with the principles and features disclosed in the present application.

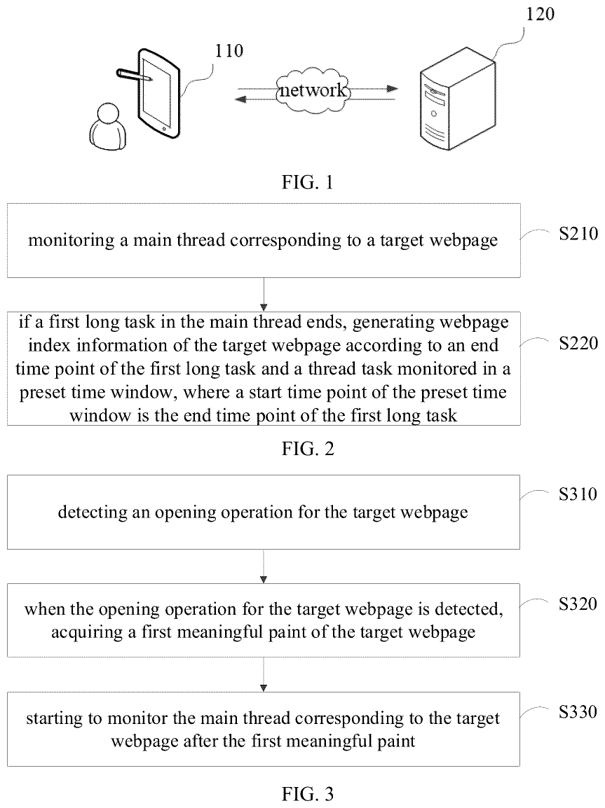

A webpage index information acquisition method provided in an embodiment of the present application can be applied to a webpage index information acquisition system shown in FIG. 1. The webpage index information acquisition system includes a terminal 110 and a server 120. The terminal 110 can be a desktop terminal or a mobile terminal. The terminal 110 can also be a mobile phone, a tablet computer, a laptop computer, etc. The server 120 can be an independent server, or a server network or a server cluster composed of servers, which includes but is not limited to a computer, a network host, a single network server, a plurality of network server sets, or a cloud server composed of a plurality of servers. The cloud server is composed of a large number of computers or network servers based on cloud computing. Specifically, the terminal 110 is installed with a browser client and presents a target webpage through the browser client. The terminal 110 can receive the user's trigger operation on the target webpage through the browser client, and then load a webpage resource from the server 120 to realize drawing and rendering of the target webpage based on the webpage resource. In the process of loading and rendering the target webpage, the terminal monitors a main thread corresponding to the target webpage. If a first long task in the main thread ends, webpage index information of the target webpage is generated based on an end time point of the first long task and a thread task monitored in a preset time window. A start time point of the preset time window is the end time point of the first long task.

The webpage index information of a webpage is an important reference parameter when optimizing the webpage. The webpage index information of the webpage includes but is not limited to: a first meaningful paint (FMP) and a time to interactive (TTI). The time to interactive refers to a time point when the webpage completes loading and rendering and can respond to interactive operations input by the user. Because tasks generated by the interaction between the user and the webpage will occupy the main thread corresponding to the webpage for a period of time, in order to ensure that the webpage can respond to the interactive operations input by the user and the smoothness of the interaction between the user and the webpage, the main thread corresponding to the webpage should be in an idle state for a certain period of time starting from the time to interactive. That is, the time to interactive refers to a time point of an idle time window when the main thread first appears after the webpage completes loading and rendering.

Those skilled in the art can understand that an application environment shown in FIG. 1 is only an application scenario of a solution of the present application, and does not constitute a limitation on the application scenario of the solution of the present application. Other application environments can also include more or fewer computer devices than those shown in FIG. 1. For example, FIG. 1 only shows one server 120. It can be understood that the webpage index information acquisition system can also include one or more other servers, which are not specifically limited here. In addition, as shown in FIG. 1, the webpage index information acquisition system can also include a memory for storing data, such as storing video surveillance data.

It should also be noted that the schematic diagram of the scenario of the webpage index acquisition system shown in FIG. 1 is only an example. The webpage index acquisition system and scenario described in the embodiment of the present application are intended to more clearly illustrate the technical solution of the embodiment of the present application, and do not constitute a limitation on the technical solution provided by the embodiment of the present application. It is known to those skilled in the art that with the evolution of the webpage index acquisition system and the emergence of new business scenarios, the technical solution provided by the embodiment of the present application is also applicable to similar technical problems.

Referring to FIG. 2, an embodiment of the present application provides a webpage index information acquisition method, which is mainly illustrated by applying the method to the terminal 110 in FIG. 1. The method includes steps S210 to S220, which are specifically as follows:

Step S210, monitoring a main thread corresponding to a target webpage.

The terminal is installed with a browser client. The terminal can present the target webpage through the browser client. The terminal loads a webpage resource from a server through the browser client, and draws and renders the target webpage based on the webpage resource. In this step, the target webpage refers to a page of any website, such as a search webpage, a shopping webpage, a video sharing platform webpage, etc. The main thread of the target webpage refers to a browser thread used by the browser client in the terminal to load the webpage resource of the target webpage from the server and draw the target webpage.

Specifically, monitoring the main thread corresponding to the target webpage refers to monitoring a task status of the thread task in the main thread, such as the start, end, start time, end time, etc. of the thread task. More specifically, thread tasks include but are not limited to long tasks and webpage resource request tasks. The long task refers to a task in the thread task that take longer than 50 milliseconds to execute. The webpage resource request task refers to the sending and receiving of HTTP requests, such as XHR requests (XML HttpRequest), Fetch requests, and static resource file requests.

Step S220, if a first long task in the main thread ends, generating webpage index information of the target webpage according to an end time point of the first long task and a thread task monitored in a preset time window; where a start time point of the preset time window is the end time point of the first long task.

The webpage index information of the target webpage can be a time to interactive (TTI) of the target webpage. A window length of the preset time window can be set based on an actual situation, for example, it can be set to 5 seconds, 4.75 seconds, etc., or it can be determined based on a time taken for the user to interact with the target webpage, or it can be set in real time based on the end time point of the first long task.

When the main thread of the target webpage is in an idle state, the main thread will execute the interactive tasks generated by the user based on the interactive operations between the target webpage. In order to ensure the response of the target webpage corresponding the main thread to the interactive tasks and the smoothness of the interaction between the user and the target webpage, the preset time window of the main thread after the time to interactive should be an idle time window without other thread tasks.

Specifically, the terminal can monitor the thread task in the main thread corresponding to the target page in real time. When a long task is monitored, the long task can be determined as the first long task, and the end time point of the first long task is recorded when the first long task ends. Then, the end time point of the first long task is taken as the start time point to start monitoring the thread task in the preset time window, and it is determined whether the preset time window is an idle time window according to the task status of the thread task in the preset time window. When the preset time window is determined to be an idle time window, the webpage index information of the target webpage is generated based on the end time point of the first long task.

In the above webpage index information acquisition method, the main thread corresponding to the target webpage is monitored. If the first long task in the main thread ends, the webpage index information of the target webpage is generated according to the end time point of the first long task and the thread task monitored in the preset time window. The start time point of the preset time window is the end time point of the first long task. By monitoring the main thread loaded by the webpage interface, the end time point of the first long task is acquired in real time, and the webpage index information of the target webpage is generated based on the end time point of the first long task and the task status of the thread task in the preset time window with the end time point of the first long task as the start time point, so as to acquire the webpage index information of the target webpage in an actual use environment of different terminals. The accuracy of the webpage index information is improved, and accurate data is provided for the optimization of webpage codes and interactive operations of the target webpage.

As mentioned above, the thread task include the long task. Since an execution time of the long task is too long, in order to ensure the response of the target webpage corresponding to the main thread to the interactive task and the smoothness of the interaction between the user and the target webpage, the preset time window of the main thread after the time to interactive should be an idle time window without the long task. Specifically, in one embodiment, the step of generating the webpage index information of the target webpage according to the end time point of the first long task and the thread task monitored in the preset time window includes: if a second long task is monitored in the preset time window, updating the second long task to the first long task, and continuing to generate the webpage index information of the target webpage according to the end time point of the first long task and the thread task monitored in the preset time window.

The second long task refers to the long task that occurs in the preset time window after the first long task ends.

When the first long task is monitored to end, the long task in the preset time window is monitored with the end time point of the first long task as the start time point to acquire whether there are long tasks in progress in the preset time window. If the second long task is monitored in the preset time window, it is considered that the preset time window with the end time point of the first long task as the start time point is not an idle window period in which the main thread is idle. In the preset time window, the terminal cannot respond to the interactive operation based on the interface input of the target webpage, and the user's interaction based on the target webpage is stuck and not smooth. At this time, the second long task can be determined to be updated as the new first long task, and when the second long task (i.e., the new first long task) ends, the end time point of the second long task is obtained, and the end time point of the second long task is taken as the start time point of the new preset time window again, and the thread task of the main thread in the new preset time window is continuously monitored.

In this embodiment, after the first long task ends, if the second long task is monitored in the preset time window, the second long task is determined to be updated as the new first long task to realize the re-determination of the start time of the new preset time window, so as to ensure that the preset time window should be free of the execution of long tasks. This prevents the main thread from being occupied by the execution of the long task and being unable to respond to the interactive operation input by the user, so that the start time point of the preset time window is the valid webpage index information, thereby improving the accuracy of the webpage index information of the target webpage.

In addition, considering an upper limit of a TCP connection between the terminal and the server, a fixed number of network resource request tasks initiated by the terminal at the same time often leads to the blocking of the webpage resource download, so that a completion time of the loading and rendering of the target webpage and the time to interactive are delayed. Moreover, the download of network resources and the loading and rendering process after the download are completed often occupy a certain amount of memory. In order to ensure the response of the main thread corresponding to the target webpage to the interactive task and the smoothness of the interaction between the user and the target webpage, the preset time window of the main thread after the time to interactive should be an idle time window with no network resource request task or as few network resource request tasks as possible. Therefore, in one embodiment, the thread task includes a webpage resource request. The step of generating the webpage index information of the target webpage according to the end time point of the first long task and the thread task monitored in the preset time window includes: acquiring a number of network resource requests monitored in the preset time window; if the number of the network resource requests is less than a preset request threshold, generating the webpage index information of the target webpage based on the end time point of the first long task.

The webpage resource request at least includes an XHR request, a Fetch request and a static resource file request. Specifically, monitoring the webpage resource request in the main thread corresponding to the target webpage can be to monitor the XHR request by proxy an XMLHttpRequest.send method, monitor the fetch request by proxy a fetch method, and monitor a loading status of static resource files by monitoring node changes through MutationObserver.

The preset request threshold can be set based on actual conditions, for example, it can be set to 3, 2, etc.

After monitoring the end of the first long task, the end time point of the first long task is taken as the start time point, the webpage resource request in the preset time window is monitored to acquire the number of the network resource requests monitored in the preset time window, and then it is determined whether the number of network resource requests monitored in the preset time window is greater than the preset request threshold. When the number of the network resource requests monitored in the preset time window is less than the preset request threshold, it is considered that the preset time window with the end time point of the first long task as the start time point is an idle window period in which the main thread is in an idle state. In the preset time window, the terminal can respond to interactive operations based on the interface input of the target webpage and the user interacts smoothly with the target webpage, and the webpage index information of the target webpage can be generated based on the end time point of the first long task.

Furthermore, when the number of the network resource requests monitored in the preset time window is greater than or equal to the preset request threshold, the preset time window with the end time point of the first long task as the start time point is considered to be a non-idle window period. At this time, the terminal can continue to monitor the main thread corresponding to the target webpage. When a next long task is monitored and the long task ends, the thread task is monitored again in the preset time window with the end time point of the long task as the start time point, and the webpage index information of the target webpage is generated according to the end time point of the long task and the task status of the thread task monitored in the preset time window.

In this embodiment, the number of the webpage resource requests in the preset time window is monitored to ensure that the preset time window should be an idle time window with no network resource request task or as few network resource request tasks as possible. This prevents the interactive operation responding to user input from being stuck due to the execution of too many webpage resource requests occupying the main thread, so that the start time point of the preset time window is valid webpage index information, thereby improving the accuracy of the webpage index information of the target webpage.

In one embodiment, the generating the webpage index information of the target webpage based on the end time point of the first long task may specifically include: determining the end time point of the first long task as a time to interactive of the target webpage.

In this embodiment, in the preset time window where the end time point of the first long task is the start time, the number of the network resource requests is less than the preset request threshold. That is, in the preset time window, the main thread is in an idle window period in an idle state. Thus, it is ensured that the main thread can respond to the interactive task between the user and the target webpage. At this time, the end time point of the first long task can be determined as the time to interactive of the target webpage, thereby improving the accuracy of the time to interactive of the target webpage.

In one embodiment, as shown in FIG. 3, the step of monitoring the main thread corresponding to the target webpage may specifically include:

S310, detecting an opening operation for the target webpage.

As mentioned above, the terminal is installed with the browser client, and the terminal can receive the opening operation of the target webpage input by the user through the browser client. Specifically, the opening operation can be a touch operation, a cursor operation, a key operation, etc.

For example, the user may input a webpage address of the target webpage based on the browser client to trigger the opening operation for the target webpage. The terminal detects the opening operation of the target webpage input by the user in real time through the browser client.

S320, when the opening operation for the target webpage is detected, acquiring a first meaningful paint of the target webpage.

The first meaningful paint (First Meaning Paint, FMP) refers to a time point when most page elements of the target webpage are rendered and drawn, which can be acquired through an API interface provided by the browser. Specifically, after detecting the opening operation for the target webpage, the terminal monitors the loading and rendering of the page elements in the target webpage in real time. When monitoring a time point when all page elements in the target webpage have been loaded and rendered, this time point is determined as the first meaningful paint of the target page.

S330, after the first meaningful paint of a target page element, starting to monitor the main thread corresponding to the target webpage.

Specifically, after the terminal determines the first meaningful paint of the target page element, it starts to monitor the main thread corresponding to the target webpage. By monitoring the main thread of the target webpage only after all page elements of the target webpage have been loaded and rendered, a performance consumption caused by the target webpage monitoring the main thread can be effectively reduced.

Furthermore, in one embodiment, acquiring the first meaningful paint of the target webpage may specifically include: acquiring a site type of the target webpage; determining a target page element from page elements of the target webpage based on the site type of the target webpage; and determining the first meaningful paint of the target page according to a loading time point of the target page element.

The site type refers to a webpage type of the target webpage. For example, the site type includes at least a search webpage type, a shopping webpage type, and an advisory information webpage type. The page element in the webpage refers to a content element displayed in the webpage. For example, text, image, table, etc. The target page element refers to a main page element in the webpage. When the target page element is rendered and drawn, it can be considered that the webpage has entered an interactive state. Specifically, the target page element in webpages of different site types is different.

For example, the target page element in the search webpage type webpage can be a search box, the target page element in the shopping webpage type webpage can be a product image on a first screen, the target page element in the advisory information webpage type webpage can be a banner image on the first screen, and so on.

Specifically, after receiving the opening operation of the target webpage, the terminal can acquire the site type corresponding to the target webpage, and determine the target page element in the page element of the target webpage according to the site type. Then, the target page element is monitored for the loading time point when it is loaded and rendered, and the loading time point is determined as the first meaningful paint of the target page. Then, the main thread of the target webpage is monitored after the first meaningful paint.

When the main page element in the target webpage has completed loading and rendering, it can be considered that the target webpage has completed loading and rendering. The target webpage can then receive and respond to interactive tasks input by the user. In this embodiment, the target page element is determined according to the site type of the target webpage. The time point when the target page element completes rendering is determined as the first meaningful paint of the target page. There is no need to wait until all page elements in the target page have completed rendering before acquiring the webpage index information such as the time to interactive, which effectively improves the accuracy of the time to interactive of the target webpage and provides accurate data for the optimization of the webpage codes and interactive operations of the target webpage.

In one embodiment, before the step of generating the webpage index information of the target webpage according to the end time point of the first long task and the thread task monitored in the preset time window, the method further includes: acquiring a webpage loading time between the first meaningful paint and the end time point of the first long task; and determining a window length of the preset time window according to the webpage loading time.

The window length of the preset time window can be set according to the webpage loading time between the first meaningful paint and the end time point of the first long task. Specifically, the webpage loading time between the first meaningful paint and the end time point of the first long task is inversely proportional to the window length of the preset time window. For example, when the webpage loading time between the first meaningful paint and the end time point of the first long task is large, the window length of the preset time window can be set to a smaller value. When the webpage loading time between the first meaningful paint and the end time point of the first long task is small, the window length of the preset time window can be set to a larger value.

Specifically, a mapping relationship between the webpage loading time and the window length of the preset time window may be preset. After the webpage loading time is acquired, a specific value of the window length of the corresponding preset time window may be acquired based on the mapping relationship.

The window length of the preset time window and the webpage loading time between the first meaningful paint and the end time point of the first long task can reflect the loading time of the target webpage. When the webpage loading time between the first meaningful paint and the end time point of the first long task is long (i.e., the loading time of the target webpage is long), the window length of the preset time window is set to a smaller value. This makes it possible for the target webpage to enter an interactive state with a higher probability at the end time point of the first long task, which reduces a time users wait for the target page to load and improves the user experience. When the webpage loading time between the first meaningful paint and the end time point of the first long task is short (i.e., the target webpage loading time is short), the window length of the preset time window is set to a larger value. This makes it possible for the target webpage to enter the interactive state with a longer idle time period, which ensures smooth interaction between the user and the target page and improves the user experience.

In this embodiment, the window length of the preset time window is flexibly set based on the webpage loading time between the first meaningful paint and the end time point of the first long task, so that the time to interactive of the target webpage can be flexibly set according to the loading situation of the target webpage, thereby improving the accuracy of the time to interactive of the target webpage and providing accurate data for optimizing the webpage codes and interactive operations of the target webpage.

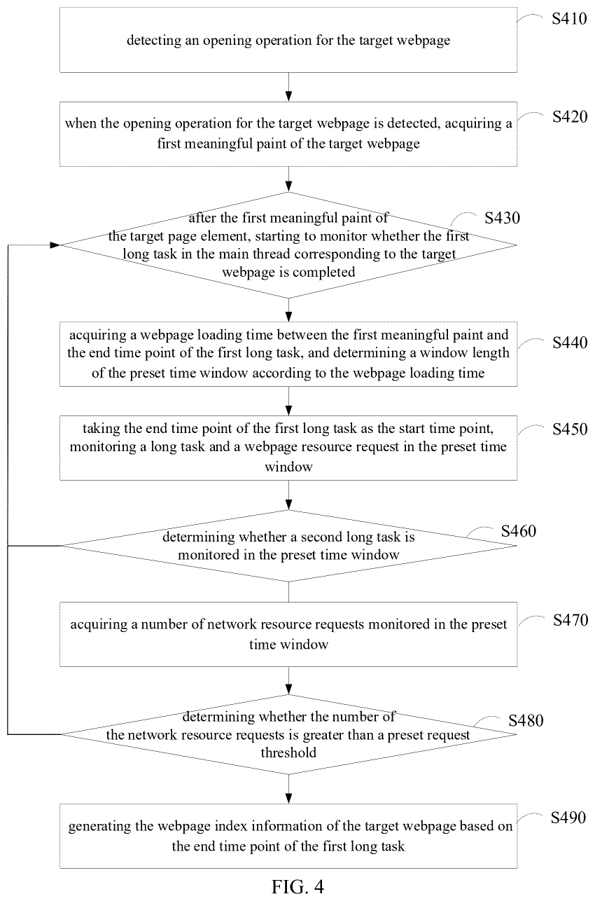

The webpage index information acquisition method is further described below in conjunction with an application scenario. In one embodiment, as shown in FIG. 4, the webpage index information acquisition method includes:

S410, detecting an opening operation for the target webpage.

S420, when the opening operation for the target webpage is detected, acquiring a first meaningful paint of the target webpage.

S430, after the first meaningful paint of the target page element, starting to monitor whether the first long task in the main thread corresponding to the target webpage is completed; if the first long task is completed, executing S440, otherwise continuing to execute S430.

S440, acquiring a webpage loading time between the first meaningful paint and the end time point of the first long task, and determining a window length of the preset time window according to the webpage loading time.

S450, taking the end time point of the first long task as the start time point, monitoring a long task and a webpage resource request in the preset time window.

S460, determining whether a second long task is monitored in the preset time window, if so, updating the second long task to the first long task, jumping to execute S430; otherwise, executing S470.

S470, acquiring a number of network resource requests monitored in the preset time window.

S480, determining whether the number of the network resource requests is greater than a preset request threshold; if so, executing S490; if not, executing S430.

S490, generating the webpage index information of the target webpage based on the end time point of the first long task.

The loading and rendering process of the target webpage includes: running JavaScript, updating a Document Object Model (DOM) and updating a style, calculating a layout on a page, and painting each layer of the layout, etc. Any step in this process will generate a long task. When the main thread executes the long task, the interactive operations input by the user usually enter the task queue and wait, resulting in the main thread of the target webpage being unable to respond to the interactive operations input by the user. At this time, the target webpage is not in an interactive state. Therefore, the end time point of the long task can be used as a candidate time point for the target webpage to enter an interactive state.

Specifically, the API interface provided by the browser client can be used to monitor whether the long task in the main thread corresponding to the target webpage has ended. When a long task ends, the long task is determined as the first long task, and the end time point of the first long task is called back. Then, the end time point of the first long task is used as the start time point to monitor the long task and webpage resource requests in the preset time window in real time. When there is no long task in the preset time window and the number of webpage resource requests is less than the preset request threshold, at this time, whether the preset time window is an idle time window, the end time point of the first long task can be determined as the time to interactive of the target webpage.

In this embodiment, the task status of the long task and the webpage resource requests in the preset time window with the end time point of the first long task as the start time point is detected to determine whether the preset time window is an idle time window. Only when the task status of the long task and the webpage resource request both meet the conditions of the idle time window, the end time point of the first long task is determined as the time to interactive of the target webpage. This can effectively improve the accuracy of the time to interactive and provide accurate data for the optimization of the webpage codes and interactive operations of the target webpage. At the same time, the target page element is determined according to the site type of the target webpage, and the time point when the target page element completes rendering is determined as the first meaningful paint of the target page, and the long task and the webpage resource requests in the preset time window are monitored. There is no need to wait until all page elements in the target page are rendered before acquiring the webpage index information such as the time to interactive. This effectively improves the accuracy of the time to interactive of the target webpage and provides accurate data for the optimization of the webpage code and interactive operations of the target webpage. In addition, considering the time users spend waiting for the target webpage to load, the window length of the preset time window is flexibly set based on the webpage loading time between the first meaningful paint and the end time point of the first long task, so that the time to interactive of the target webpage can be flexibly set according to the loading status of the target webpage. This improves the accuracy of the time to interactive of the target webpage and provides accurate data for the optimization of the webpage codes and interactive operations of the target webpage.

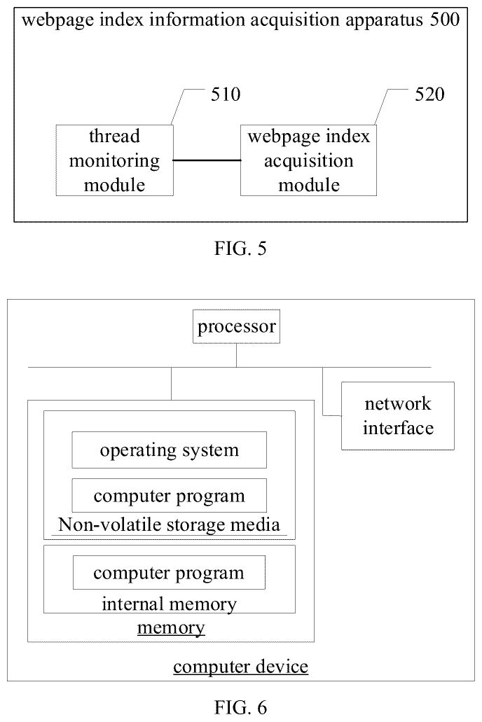

In order to better implement the webpage index information acquisition method provided in the embodiment of the present application, on the basis of the webpage index information acquisition method provided in the embodiment of the present application, a webpage index information acquisition apparatus is further provided in an embodiment of the present application. As shown in FIG. 5, the webpage index information acquisition apparatus 500 includes:

A thread monitoring module 510 configured to monitor a main thread corresponding to a target webpage.

A webpage index acquisition module 520 configured to generate webpage index information of the target webpage according to an end time point of a first long task and a thread task monitored in a preset time window when the first long task in the main thread ends; where a start time point of the preset time window is the end time point of the first long task.

In some embodiments of the present application, the thread task includes a long task. The webpage index acquisition module 520 is configured to update a second long task to the first long task when the second long task is monitored in the preset time window, and continue to generate the webpage index information of the target webpage according to the end time point of the first long task and the thread task monitored in the preset time window.

In some embodiments of the present application, the thread task includes a webpage resource request. The webpage index acquisition module 520 is configured to acquire a number of network resource requests monitored in the preset time window; if the number of the network resource requests is less than a preset request threshold, generate the webpage index information of the target webpage based on the end time point of the first long task.

In some embodiments of the present application, the webpage index acquisition module is configured to determine the end time point of the first long task as a time to interactive of the target webpage.

In some embodiments of the present application, the thread monitoring module is configured to detect an opening operation for the target webpage; when the opening operation for the target webpage is detected, acquire a first meaningful paint of the target webpage; and start to monitor the main thread corresponding to the target webpage after the first meaningful paint.

In some embodiments of the present application, the thread monitoring module is configured to acquire a site type of the target webpage; determine a target page element from page elements of the target webpage based on the site type of the target webpage; and determine the first meaningful paint of the target webpage according to a loading time point of the target page element.

In some embodiments of the present application, the thread monitoring module is also configured to acquire a webpage loading time between the first meaningful paint and the end time point of the first long task; and determine a window length of the preset time window according to the webpage loading time.

For the specific definition of the webpage index information acquisition apparatus, please refer to the definition of the webpage index information acquisition method above, which will not be repeated here. Each module in the above webpage index information acquisition apparatus can be implemented in whole or in part by software, hardware, and a combination thereof. The above modules can be embedded in or independent of a processor in a computer device in the form of hardware, or can be stored in a memory in the computer device in the form of software, so that the processor can call and execute the operations corresponding to the above modules.

In some embodiments of the present application, the webpage index information acquisition apparatus 500 can be implemented in the form of a computer program. The computer program can be run on a computer device as shown in FIG. 6. A memory of the computer device can store various program modules constituting the webpage index information acquisition apparatus 500, such as the thread monitoring module 510 and the webpage index acquisition module 520 shown in FIG. 5. The computer program composed of the various program modules enables a processor to execute the steps in the webpage index information acquisition method of various embodiments of the present application described in this specification.

For example, the computer device shown in FIG. 6 can perform the step S210 through the thread monitoring module 510 in the webpage index information acquisition apparatus 500 shown in FIG. 5. The computer device can perform the step S220 through the webpage index acquisition module 520. The computer device includes a processor, a memory, and a network interface connected through a system bus. The processor of the computer device is used to provide computing and control capabilities. The memory of the computer device includes a non-volatile storage medium and an internal memory. The non-volatile storage medium stores an operating system and a computer program. The internal memory provides an environment for the operation of the operating system and the computer program in the non-volatile storage medium. The network interface of the computer device is used to communicate with an external computer device through a network connection. When the computer program is executed by the processor, the webpage index information acquisition method is implemented.

Those skilled in the art will appreciate that the structure shown in FIG. 6 is merely a block diagram of a portion of a structure related to a solution of the present application, and does not constitute a limitation on the computer device to which the solution of the present application is applied. Specifically, the computer device may include more or fewer components than those shown in the figure, or combine certain components, or have a different arrangement of components.

In some embodiments of the present application, a computer device is provided, including one or more processors; a memory; and one or more applications, where the one or more applications are stored in the memory and configured to be executed by the processor to implement steps of the webpage index information acquisition method described above. The steps of the webpage index information acquisition method here may be the steps of the webpage index information acquisition method in the above-mentioned various embodiments.

In some embodiments of the present application, a computer-readable storage medium is provided, which stores a computer program, and the computer program is loaded by a processor, so that the processor executes steps of the webpage index information acquisition method. The steps of the webpage index information acquisition method here can be the steps of the webpage index information acquisition method in each of the above embodiments.

Those of ordinary skill in the art can understand that all or part of the processes in the above-mentioned embodiment methods can be completed by instructing the relevant hardware through a computer program. The computer program can be stored in a non-volatile computer-readable storage medium. When the computer program is executed, it can include the processes of the embodiments of the above-mentioned methods. Any reference to memory, storage, database or other media used in the embodiments provided in this application can include at least one of non-volatile and volatile memory. The non-volatile memory can include a read-only memory (ROM), tape, a floppy disk, a flash memory or an optical memory, etc. The volatile memory can include a random access memory (RAM) or an external cache memory. As an illustration and not limitation, the RAM can be in various forms, such as static random access memory (SRAM) or dynamic random access memory (DRAM).

The technical features of the above embodiments may be combined arbitrarily. To make the description concise, not all possible combinations of the technical features in the above embodiments are described. However, as long as there is no contradiction in the combination of these technical features, they should be considered to be within the scope of this specification.

The webpage index information acquisition method and apparatus, the computer device, and the storage medium provided in the embodiments of the present application are introduced in detail above. The principles and implementation methods of the present application are explained in this specification using specific examples. The description of the above embodiments is only used to help understand the method of the present application and its core idea. At the same time, for technical personnel in this field, according to the idea of the present application, there will be changes in the specific implementation method and application scope. In summary, the content of this specification should not be understood as a limitation on the present application.

1. A webpage index information acquisition method, wherein the method comprises:
monitoring a main thread corresponding to a target webpage; and
if a first long task in the main thread ends, generating webpage index information of the target webpage according to an end time point of the first long task and a thread task monitored in a preset time window, wherein a start time point of the preset time window is the end time point of the first long task.

2. The method according to claim 1, wherein the thread task comprises a long task;
the generating the webpage index information of the target webpage according to the end time point of the first long task and the thread task monitored in the preset time window comprises:
if a second long task is monitored in the preset time window, updating the second long task to the first long task, and continuing to generate the webpage index information of the target webpage according to the end time point of the first long task and the thread task monitored in the preset time window.

3. The method according to claim 1, wherein the thread task comprises a webpage resource request;
the generating the webpage index information of the target webpage according to the end time point of the first long task and the thread task monitored in the preset time window comprises:
acquiring a number of network resource requests monitored in the preset time window;
if the number of the network resource requests is less than a preset request threshold, generating the webpage index information of the target webpage based on the end time point of the first long task.

4. The method according to claim 3, wherein the generating the webpage index information of the target webpage based on the end time point of the first long task comprises:
determining the end time point of the first long task as a time to interactive of the target webpage.

5. The method according to claim 1, wherein the monitoring the main thread corresponding to the target webpage comprises:
detecting an opening operation for the target webpage;
when the opening operation for the target webpage is detected, acquiring a first meaningful paint of the target webpage;
starting to monitor the main thread corresponding to the target webpage after the first meaningful paint.

6. The method according to claim 5, wherein the acquiring the first meaningful paint of the target webpage comprises:
acquiring a site type of the target webpage;
determining a target page element from page elements of the target webpage based on the site type of the target webpage;
determining the first meaningful paint of the target webpage according to a loading time point of the target page element.

7. The method according to claim 5, wherein before generating the webpage index information of the target webpage according to the end time point of the first long task and the thread task monitored in the preset time window, the method further comprises:
acquiring a webpage loading time between the first meaningful paint and the end time point of the first long task;
determining a window length of the preset time window according to the webpage loading time.

8. The method according to claim 7, wherein the webpage loading time between the first meaningful paint and the end time point of the first long task is inversely proportional to the window length of the preset time window.

9. The method according to claim 5, wherein the acquiring the first meaningful paint of the target webpage comprises:
after detecting the opening operation for the target webpage, real-time monitoring of loading and rendering of page elements of the target webpage;
when monitoring a time point at which all page elements of the target webpage are loaded and rendered, determining the time point at which all page elements are loaded and rendered as the first meaningful paint of the target page.

10. The method according to claim 3, wherein the method further comprises:
when the number of the network resource requests monitored in the preset time window is greater than or equal to the preset request threshold, continuing to monitor the main thread corresponding to the target webpage;
when a next long task is monitored and the next long task ends, taking an end time point of the next long task as a start time point, monitoring the thread task again in the preset time window;
generating the webpage index information of the target webpage according to the end time point of the next long task and a task status of the thread task monitored in the preset time window.

11. The method according to claim 6, wherein the site type comprises at least a search webpage type, a shopping webpage type, and an advisory information webpage type; the target page element in the target webpage of the search webpage type is a search box; the target page element in the target webpage of the shopping webpage type is a product image on a first screen; the target page element in the target webpage of the advisory information webpage type is a banner image on the first screen.

12. The method according to claim 1, wherein the generating the webpage index information of the target webpage according to the end time point of the first long task and the thread task monitored in the preset time window if the first long task in the main thread ends comprises:
recording the end time point of the first long task when the first long task ends;
taking the end time point of the first long task as the start time point, starting to monitor the thread task in the preset time window, and determining whether the preset time window is an idle time window according to a task status of the thread task in the preset time window;
when it is determined that the preset time window is the idle time window, generating the webpage index information of the target webpage based on the end time point of the first long task.

13. The method according to claim 3, wherein the method further comprises:
when the number of the network resource requests monitored in the preset time window is greater than or equal to the preset request threshold, continuing to monitor the main thread corresponding to the target webpage;
when a next long task is monitored and the next long task ends, taking an end time point of the next long task as the start time point, monitoring the thread task again in the preset time window, and generating the webpage index information of the target webpage according to the end time point of the next long task and a task status of the thread task monitored in the preset time window.

14. A webpage index information acquisition apparatus, wherein the apparatus comprises:
a thread monitoring module configured to monitor a main thread corresponding to a target webpage; and
a webpage index acquisition module configured to generate webpage index information of the target webpage according to an end time point of a first long task and a thread task monitored in a preset time window when the first long task in the main thread ends, wherein a start time point of the preset time window is the end time point of the first long task.

15. The apparatus according to claim 14, wherein the thread task comprises a long task; and the webpage index acquisition module is configured to: when a second long task is monitored in the preset time window, update the second long task to the first long task, and continue to generate the webpage index information of the target webpage according to the end time point of the first long task and the thread task monitored in the preset time window.

16. The apparatus according to claim 14, wherein the thread task comprises a webpage resource request; and the webpage index acquisition module is configured to: acquire a number of network resource requests monitored in the preset time window; if the number of the network resource requests is less than a preset request threshold, generate the webpage index information of the target webpage based on the end time point of the first long task.

17. The apparatus according to claim 16, wherein the webpage index acquisition module is configured to determine the end time point of the first long task as a time to interactive of the target webpage.

18. The apparatus according to claim 14, wherein the thread monitoring module is configured to: detect an opening operation for the target webpage; when the opening operation for the target webpage is detected, acquire a first meaningful paint of the target webpage; and start to monitor the main thread corresponding to the target webpage after the first meaningful paint.

19. A computer device, wherein the computer device comprises:
one or more processors;
a memory; and
one or more applications, wherein the one or more applications are stored in the memory and configured to be executed by the processor to implement steps of:
monitoring a main thread corresponding to a target webpage; and
if a first long task in the main thread ends, generating webpage index information of the target webpage according to an end time point of the first long task and a thread task monitored in a preset time window, wherein a start time point of the preset time window is the end time point of the first long task.

20. (canceled)

21. The computer device according to claim 19, wherein the thread task comprises a long task; if a second long task is monitored in the preset time window, the one or more applications are stored in the memory and configured to be executed by the processor to implement updating the second long task to the first long task, and continuing to generate the webpage index information of the target webpage according to the end time point of the first long task and the thread task monitored in the preset time window.
